(19) United States
(12) Patent Application Publication
(10) Pub. No.: US 2005/0170782 A1
(43) Pub. Date: Aug. 4, 2005

(54) Method and apparatus to compensate quantization error of channel quality report

(75) Inventors: Zhigang Rong, Irving, TX (US); Lin Ma, Irving, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/771,938

(22) Filed: Feb. 4, 2004

(51) Int. Cl. H04B 17/00

(52) U.S. Cl. 455/67.11; 455/226.1

(57) ABSTRACT

In one aspect this invention provides a wireless communication system (5) that includes a mobile station (20) having circuitry (22, 24, 26) and a computer program controlling operation of the circuitry to make a measurement from a forward channel to obtain a measurement result value, to quantize the measurement result value in accordance with an N level quantization to obtain a code, and to report the code on a reverse channel. The wireless communication system further includes a base station (10) having circuitry (12, 14, 16) and a computer program controlling operation of the circuitry to convert the code to a number, to compare the number to a threshold and, if the comparison indicates that the number may not accurately reflect the measurement result value, to adjust the number using an adjustment factor. In these embodiments the adjustment factor, also referred to as Delta, may be a constant, or it may be a variable. In one embodiment Delta is computed by the mobile station, and is reported to the base station.

### TECHNICAL FIELD

This invention relates generally to mobile device or mobile station channel quality measuring and reporting functions in a wireless communications system and, more specifically, relates to the reporting of channel quality information from a mobile station (MS) to a base station (BS) in a cdma2000 1xEV-DV system.

### BACKGROUND

During operation of the cdma2000 1xEV-DV system the MS sends channel quality information back to the serving BS to facilitate packet scheduling and transmission format selection. The channel quality is measured as (Ec/Nt)_{Pilot}, i.e., the signal to noise ratio Ec/Nt of the forward pilot channel of the serving base station. In order to conserve reverse link bandwidth the MS only periodically transmits full channel quality reports (for example, every 20 milliseconds), and transmits shorter duration differentially encoded reports otherwise (for example, every 1.25 milliseconds). When transmitting the full channel quality report the MS quantizes a Channel Quality Indicator (CQI) measurement into 16 levels, and maps the quantized CQI measurement value to a 4-bit CQI Value. The 4-bit CQI value is carried on the R-CQICH (Reverse Channel Quality Indicator Channel) from the MS to the BS.

The CQI feedback from the MS to the BS is important in that it is utilized to determine the transmission priority of MS packets, to select the transmission format on the Forward Packet Data Channel (F-PDCH), and to set the power level of the Forward Packet Data Control Channel (F-PDCCH).

As can be appreciated, the quantization of the CQI measurement introduces some amount of error, which tends to be greater in value when the CQI measurement is out of the quantization range. This condition may occur quite often for a MS with low geometry (near a boundary of the cell of the serving BS) and a lack of diversity, as the channel may fall into a deep fade and cause the CQI measurement to have a value far below the lower boundary of the quantization range.

For example, and referring to the MS Table in FIG. 1, in cdma2000, Rev. C, two thresholds are specified for the MS: −15.5 dB for a minimum and 5.5 dB for a maximum CQI measurement. All CQI measurement values that fall below −15.5 dB are mapped to “0000”, and all CQI measurement values that fall above 5.5 dB are mapped to “1111”. As a result, a MS that measures a (Ec/Nt)_{Pilot} of −23 dB will map this value to “0000”, even though the measured value is significantly less than the −15.5 dB minimum threshold value. Referring to the BS Table in FIG. 2, upon receiving the CQI value of “0000”, the BS interprets it as −16.25 dB, and the quantization error in this example will be 6.75 dB. The result, as shown in the plot of CQI feedback vs. time in FIG. 3, is the occurrence of clipping of the negative excursions of the (Ec/Nt)_{Pilot} measurement values reported by the MS. Note that while positive clipping could occur as well, in almost all cases the result will be clipping of the negative excursions, as shown, due to the presence of deep fades and other channel impairments. As can be appreciated, if the BS scheduler selects to transmit packets to the MS during the time that the signal is clipped, the potentially large error between the indicated and the actual channel quality can result in too low of a power setting of the F-PDCCH, and the packet transmission to the MS may readily fail.

It is well-known that increasing the number of quantization levels will reduce the amount of the quantization error. However, for cdma2000, Rev. C, the number of bits for CQI encoding is specified to be four, thereby fixing the number of quantization levels at 16.

It is also known that a range of values encoded by N quantization levels can be broadened. For example, in the instant case the 16 quantization levels could be used to define a CQI measurement range between −25 dB to +7 dB. However, in this case each of the encoded values would cover a wider range, and the CQI reporting would be made less precise.

A U.S. patent of general interest in this area is commonly assigned U.S. Pat. No. 6,295,289 B1, “Power Control in a Transmitter”, by D. M. Ionescu and G. Mandyam. This U.S. patent discloses a method and an apparatus to control power in a communication device. The method includes storing a sequence of downlink signal samples, calculating a downlink signal estimate and an uplink signal estimate, and setting a transmission power level based on the estimated uplink signal. The downlink signal estimate is calculated using the sequence of downlink signal samples and a first sequence of tap coefficients, while the uplink signal estimate is calculated using a sequence previous uplink signal estimates and a second sequence of tap coefficients.

While well suited for its intended purpose, this U.S. patent does not solve all of the problems referred to above.

### SUMMARY OF THE PREFERRED EMBODIMENTS

The foregoing and other problems are overcome, and other advantages are realized, in accordance with the presently preferred embodiments of these teachings.

In one aspect this invention provides a method to determine a channel quality metric in a wireless communication system. The method includes (a) making a measurement from a forward channel to obtain a measurement result value, quantizing the measurement result value in accordance with an N level quantization to obtain a code, and reporting the code on a reverse channel; (b) converting the reported code to a number; (c) comparing the number to a threshold and, if the comparison indicates that the number may not accurately reflect the measurement result value, (d) adjusting the number using an adjustment factor.

In another aspect this invention provides a wireless communication system that includes a mobile station having circuitry and a computer program controlling operation of the circuitry to make a measurement from a forward channel to obtain a measurement result value, to quantize the measurement result value in accordance with an N level quantization to obtain a code, and to report the code on a reverse channel. The wireless communication system further includes a base station having circuitry and a computer program controlling operation of the circuitry to convert the code to a number, to compare the number to a threshold and, if the comparison indicates that the number may not accurately reflect the measurement result value, to adjust the number using an adjustment factor.

In these embodiments the adjustment factor, also referred to herein as Delta, may be a constant, or it may be a variable. In one embodiment Delta is computed by the mobile station, and is reported to the base station.

In a further aspect this invention provides a network infrastructure component, such as a base station, of a wireless communication system. The network infrastructure component contains or is coupled to circuitry and a computer program controlling operation of the circuitry to receive a code from a mobile station, the code being indicative of a quantized result of a measurement result value obtained from a forward channel, to convert the code to a number, to compare the number to a threshold and, if the comparison indicates that the number may not accurately reflect the measurement result value, to adjust the number using the adjustment factor.

In a still further aspect this invention provides a mobile station component of a wireless communication system. The mobile station component includes circuitry and a computer program controlling operation of the circuitry to make a measurement from a forward channel to obtain a measurement result value, to quantize the measurement result value in accordance with an N level quantization to obtain a code, to report the code on a reverse channel to the wireless communication system infrastructure component, and to determine a value of the adjustment factor for use by the infrastructure component when processing the code. The value of the adjustment faction is determined by being responsive to a period of time when the obtained codes do not accurately reflect actual measurement result values to determine a difference between individual ones of actual measurement result values and a threshold measurement result value, to average the difference values and to report the average of the difference values as the adjustment factor to the infrastructure component.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 shows a CQI Value Coding Table used by the MS;

FIG. 2 shows a corresponding Accumulator Value Mapping Table used by the BS;

FIG. 3 is an exemplary plot of the variation in the CQI feedback values as a function of time, and shows two episodes of negative clipping due to a large quantization error at the MS;

FIG. 4 shows a simplified block diagram of a wireless communications system that includes a BS and a MS;

FIG. 5 is logic flow diagram in accordance with a first embodiment of this invention;

FIG. 6 is logic flow diagram in accordance with a second embodiment of this invention;

FIG. 7 illustrates in a graphical format an example of the operation of the second embodiment of this invention;

FIG. 8 is graph that depicts a result of a simulation of a VoIP application and shows a voice outage rate vs. a number of users per BS cell sector, with and without the CQI quantization error adjustment in accordance with this invention; and

FIG. 9 shows an exemplary cell containing MSs with different geometries, and the corresponding use of different Delta values by the BS.

### DETAILED DESCRIPTION OF THE PREFERRED EMBODIMENTS

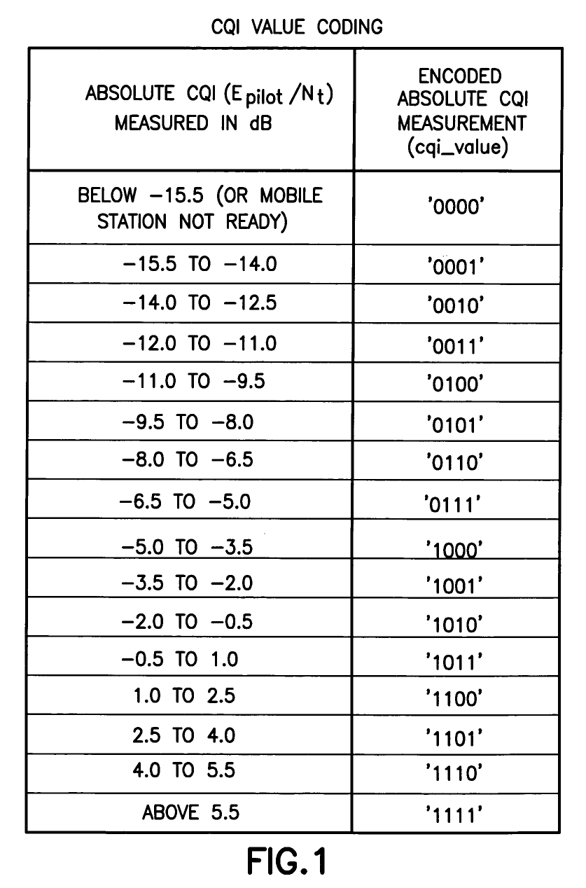

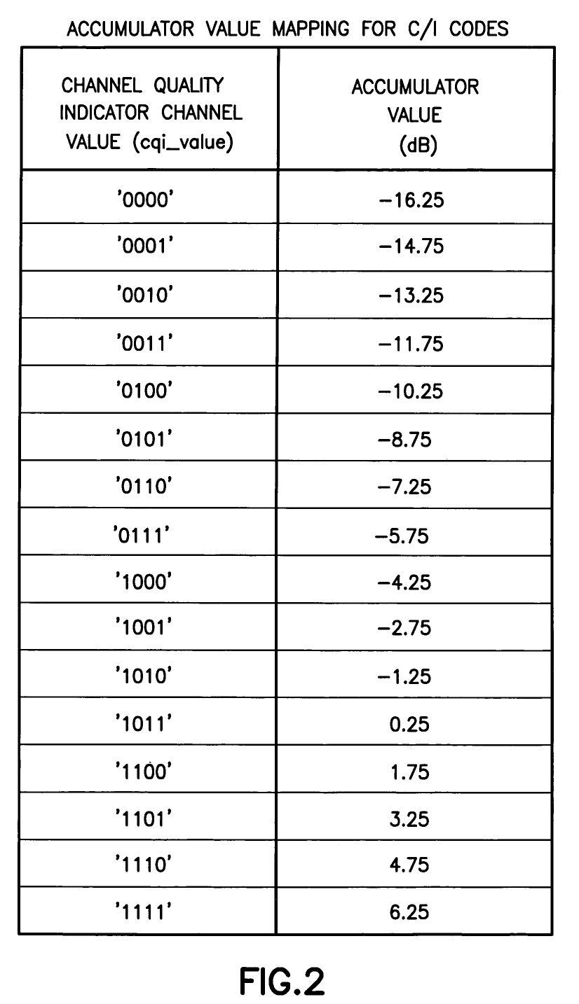

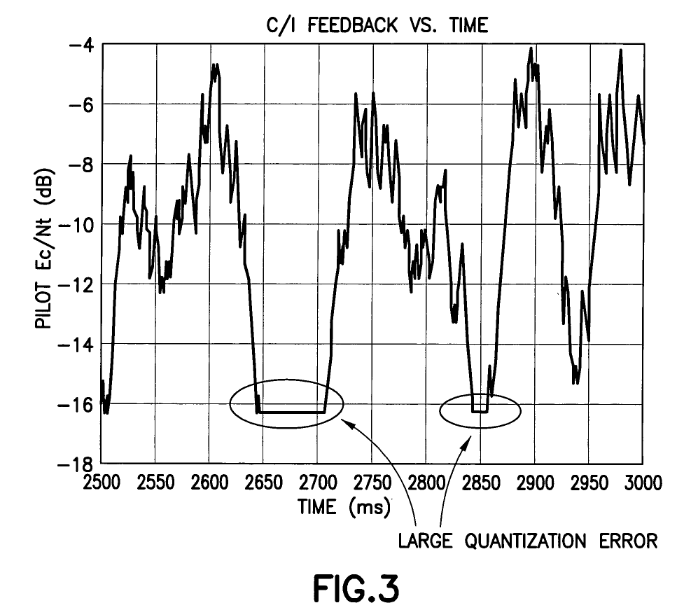

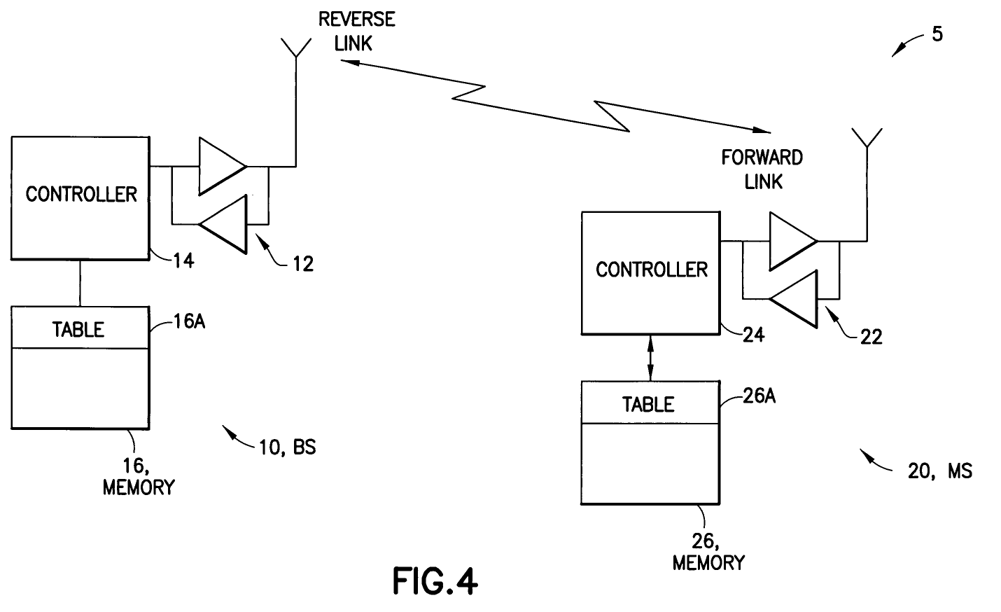

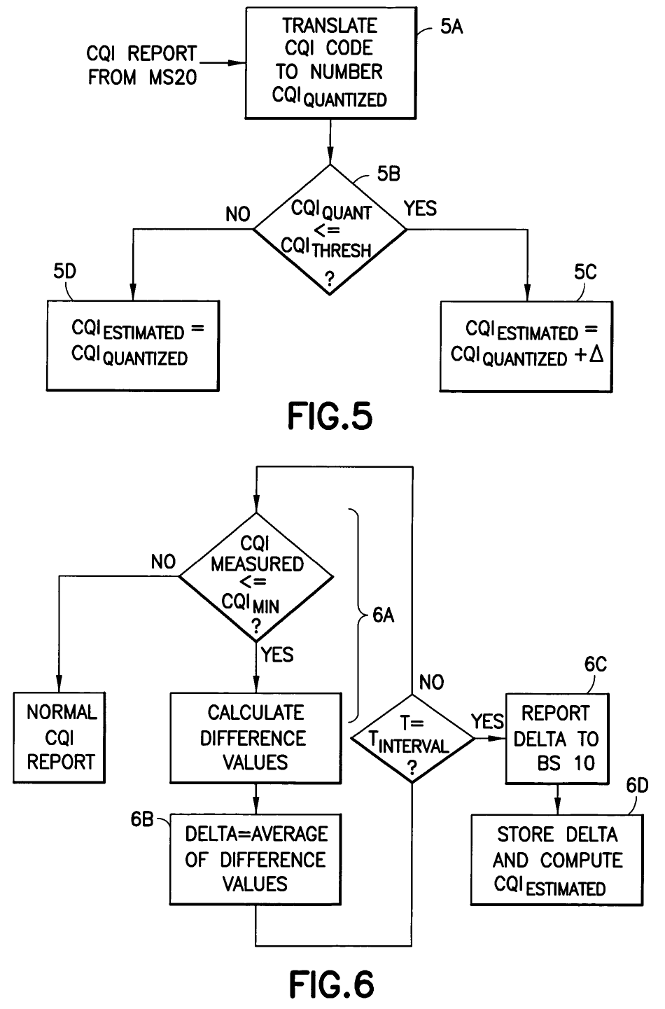

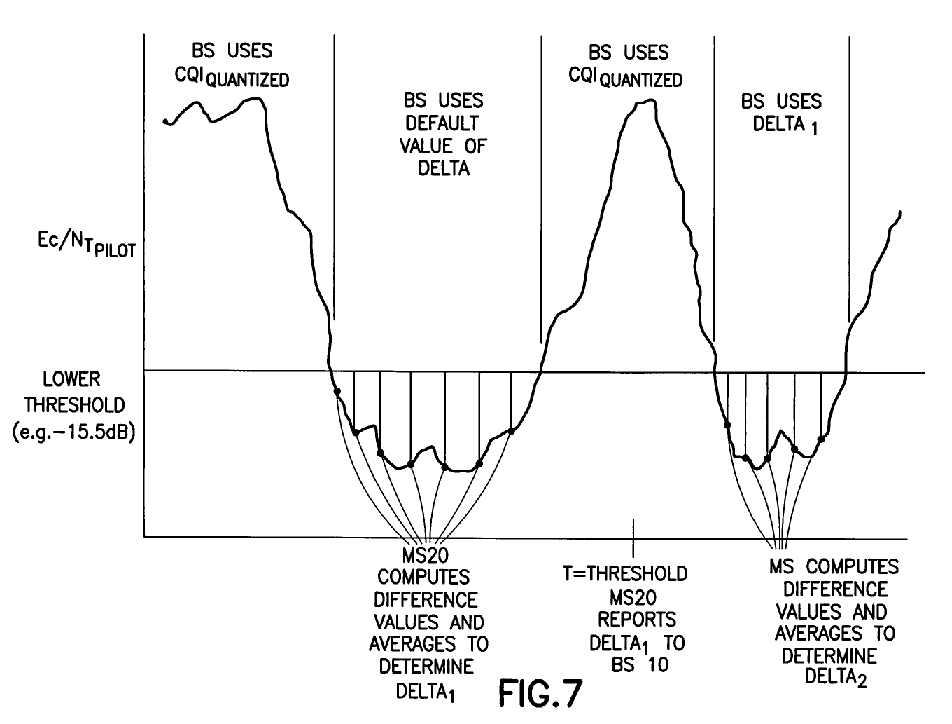

Reference is made first to FIG. 4 for showing a simplified block diagram of a wireless communications system 5 that includes a BS 10 and a MS 20. The system 5 is assumed to be one that operates in accordance with a cdma2000 1xEV-DV or similar air interface, and that provides for channel quality reporting from the MS 20 to the BS 10. The MS 20 includes an RF transceiver 22 coupled to a MS controller 24, and is operable for performing channel quality measurements based on (Ec/Nt)_{Pilot} and for reporting quantized CQI measurements back to the BS 10. To this end a memory 26 is coupled to the controller 24, and stores a data structure 26A that is equivalent to the Table shown in FIG. 1. The memory 26 is also understood to contain a computer program for directing the controller 24, such as a general purpose data processor or a digital signal processor (DSP), to execute the methods in accordance with this invention (e.g., to execute a process in accordance with the logic flow diagram of FIG. 6). The BS 10 includes an RF transceiver 12 coupled to a BS controller 14, and is operable for receiving the reported quantized CQI measurements from the MS 20. The BS 10 also includes a memory 16 coupled to the controller 14 that stores a data structure 16A that is equivalent to the Table shown in FIG. 2. The memory 16 is understood as well to contain a computer program for directing the BS controller 14, such as a general purpose data processor or a DSP, to execute the methods in accordance with this invention (e.g., to execute a process in accordance with the logic flow diagram of FIG. 5 to obtain an improved value of a channel quality metric). Based on the reported CQI measurement values, and computed, adjusted CQI measurement values in accordance with this invention, the BS controller 14 may operate to perform at least MS packet scheduling and transmission format selection, as was discussed previously.

It should be noted that the BS controller 14 may take other factors into consideration when performing the MS packet scheduling, etc. operations, and not just the CQI values. For example, the BS controller 14 may also consider user-requested quality of service (QoS) parameter(s), and/or the total loading of the system 5 and the available power budget, and/or other factors that may be apparent to those skilled in the art.

In accordance with this invention, the controller 14 of the BS 10 applies a quantization error adjustment to CQI reports received from the MS 20 to estimate an actual value of the CQI measurement at the MS 20. The value of the quantization error adjustment may be established based on the value of the CQI measurement report, or it may be established based on a recommended value sent from the MS 20.

Referring also to FIG. 5, in a first embodiment of this invention the following procedure is performed.

At Block 5A, and upon receiving the CQI report from the MS 20, the BS controller 14 translates the quantized CQI code to a number, CQI_{Quantized}, and at Block 5B compares this number to a threshold, CQI_{Threshold}, which is preferably set to the smallest CQI value in the quantization mapping table 16A (i.e., to −16.25 dB for the Table shown in FIG. 2). If CQI_{Quantized} is less than or equal to CQI_{Threshold}, at Block 5C the controller 14 of the BS 10 estimates the CQI measurement as:
CQI_{Estimated}=CQI_{Quantized}+Delta,
where CQI_{Estimated} is the estimation of CQI measurement, and Delta is a quantization error adjustment value or factor used by the BS 10. Otherwise, at Block 5D the BS 10 sets CQI_{Estimated} to CQI_{Quantized}.

One suitable value for Delta is about −5 dB. In general, the value of Delta may be in a range of about 0 dB to about −20 dB, and more preferably in a range of about 0 dB to about −10 dB.

As an example, if one assumes as a non-limiting case that the value of Delta is −5 dB, and if the MS 20 measured a value of −23 dB for (Ec/Nt)_{Pilot} and reported this measurement as CQI_value=0000 based on Table 26A (FIG. 1), then the BS 10 will arrive at a value for CQI_{Estimated} that is equal to CQI_{Quantized} (−16.25 dB from Table 16A, FIG. 2)+Delta (−5 dB) or −21.25 dB, a value that much more closely approximates the value of −23 dB that was actually measured by the MS 20. As can be appreciated, subsequent decisions made by the BS 10 regarding the transmission priority of MS 20 packets, the selection of the transmission format on the F-PDCH (e.g., modulation scheme, encoder packet size, frame duration), and the setting of the power level of the F-PDCCH will be more accurate than decisions based solely on the lowest CQI value available from the Table 16A (FIG. 2).

Referring to FIG. 6, in a second embodiment of this invention at Block 6A the MS 20 calculates the difference (delta) between each CQI measurement and the CQI quantization value whenever the CQI measurement is lower than a threshold, CQI_{Threshold}, which is preferably set to the lowest CQI value in the quantization mapping table 26A (i.e., to −15.5 dB for the Table shown in FIG. 1). At Block 6B the MS 20 averages these difference values, and at Block 6C reports the average difference value as Delta to the BS 10 every T_{Interval} milliseconds, where T_{Interval} may be fixed or may be a variable system parameter that is set by the BS 10 and sent to the MS 20 through the use of signalling, preferably upper layer signaling. T_{Interval} may be set to a value that is significantly greater than the period of the CQI full report to reduce the overhead needed to report Delta. For example, if the CQI full report period is 20 milliseconds, then a suitable value for T_{Interval} may be about 200 milliseconds. Upon receiving Delta, at Step 6D the BS 10 stores the received value of Delta in the memory 16 and subsequently uses the stored value to estimate the CQI measurement as in the first embodiment described above and shown in FIG. 5, where instead of using a BS 10 set value of Delta the BS 10 uses the value of Delta reported to it by the MS 20.

Note that the adjustment factor Delta could be based on other than an average of the individual differences. As but one example, the mean of the individual differences may be employed. In general, the adjustment factor Delta is based on some combination of the individual difference values.

FIG. 7 shows an example of this procedure in a graphical form, where it is assumed that during the illustrated time interval the MS 20 experiences two fades that result in the (Ec/Nt)_{Pilot} measurement being less than the threshold value of −15.5 dB. During the first fade the BS 10 may use a default value of Delta (e.g., 5 dB) to compute CQI_{Estimated}, as per the first embodiment described above in relation to FIG. 4. During this period, however, the MS 20 is repetitively measuring (Ec/Nt)_{Pilot}, such as every 1.25 milliseconds, computing the difference values (the difference between the measured value and the lower threshold value) and averaging the measured difference values. At some time after the fade when T=T_{Threshold} the MS 20 reports the average measurement value as Delta₁ (e.g., −6 dB) to the BS 10. During the second, subsequent fade the BS 10 uses the value of Delta₁ received from the MS 20 (−6 dB), instead of the default value (−5 dB), when computing CQI_{Estimated}. Meanwhile, during the second fade the MS 20 is calculating a new, revised value of Delta that will be subsequently reported to the BS 10 as Delta₂. In this manner the BS 10 is enabled to even more accurately estimate the value of the (Ec/Nt)_{Pilot} measured by the MS 20 for use in selecting, for example, the transmission priority of MS 20 packets, the selection of the transmission format on the F-PDCH, and the setting of the power level of the F-PDCCH.

With the use of the first embodiment (FIG. 5), and assuming the exemplary values used above, the error is reduced from 6.75 dB (−16.25+23) to 1.75 dB (−21.25+23). In the second embodiment (FIGS. 6 and 7), however, the value of Delta is reported from the MS 20 as −6 dB and CQI_{Estimated} becomes −16.25−6=−22.25 dB, resulting in the error in the CQI calculation by the BS 10 being reduced to only 0.75 dB.

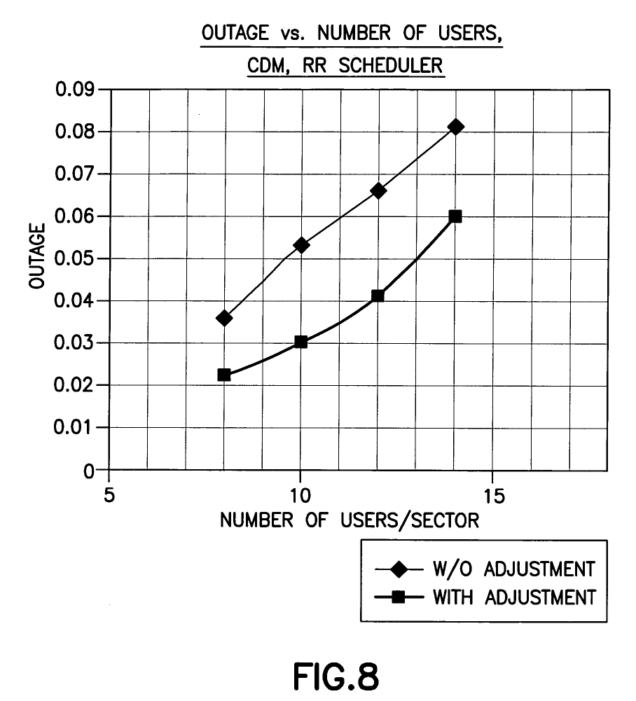

FIG. 8 shows the result of simulations performed for a voice over IP (VoIP) scenario using the 1xEV-DV F-PDCH. FIG. 8 shows the voice outage rate vs. number of users per sector with and without the use of the CQI quantization error adjustment in accordance with this invention. Clearly, with the use of the CQI quantization error adjustment the voice outage rates are much lower than without the CQI quantization error adjustment, under the same number of voice users. For an outage level of 3%, without the CQI quantization error adjustment, one observes a capacity of about seven users/sector, while with CQI quantization error adjustment one observes a capacity of 10 users/sector, a gain of more than 40%.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims.

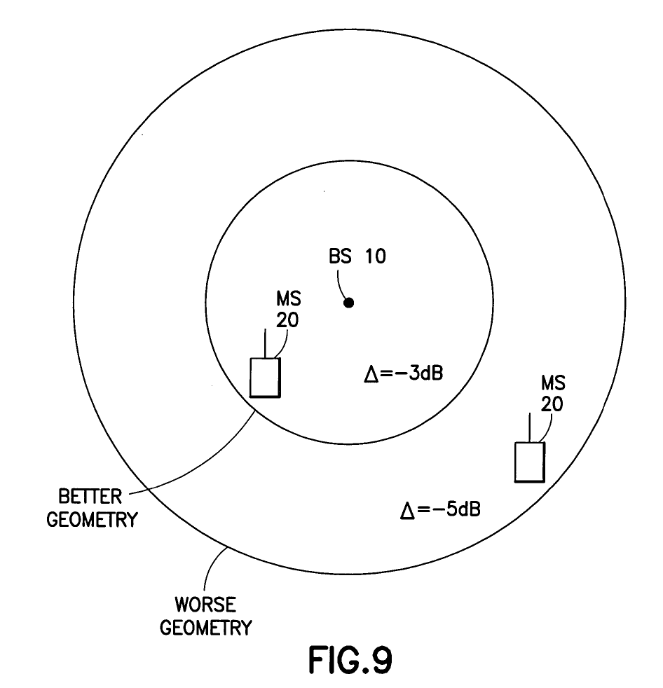

As but a few examples of such modifications, the use of other similar or equivalent values for Delta and related thresholds may be attempted, as may other Delta reporting techniques be attempted by those skilled in the art. Also, it should be appreciated that the controller 14 and memory 16 shown in FIG. 4 need not be physically resident in the BS 10, and could be located elsewhere in the wireless network infrastructure, such as at a base station controller (not shown) that operates with a plurality of the BSs 10. Also, in the first embodiment the BS 10 may use different values for Delta for different MSs 20, depending on the geometry of the MSs. For example, and referring to FIG. 9, for those MSs 20 that are closer to the BS 10 than others (and thus have a better geometry) the BS 10 may use a Delta value of −3 dB, while for the other, further MSs the BS 10 may use a value of −5 dB. This applies as well to the second embodiment, where the BS 10 is enabled to use a variable default Delta value before the MS 20 reports the first averaged CQI measurement values as Delta₁. The locations of the MSs 20 can be inferred by the BS 10 from, as a few examples, location reporting techniques, such as those based on GPS, or from pilot signal strength measurements that are periodically reported by the MS 20 in a Pilot Strength Measurement Message.

Also, while described above primarily in the context of packet switched (PS) embodiments, it should also be appreciated that at least some aspects of this invention can be used as well in circuit switched (CS) applications.

Thus, it is to be understood that all such and similar modifications of the teachings of this invention will still fall within the scope of this invention. Furthermore, some of the features of the present invention could be used to advantage without the corresponding use of other features. As such, the foregoing description should be considered as merely illustrative of the principles of the present invention, and not in limitation thereof.

1. A method to determine a channel quality metric in a wireless communication system, comprising:
making a measurement from a forward channel to obtain a measurement result value, quantizing the measurement result value in accordance with an N level quantization to obtain a code, and reporting the code on a reverse channel;
converting the reported code to a number;
comparing the number to a threshold; and
if the comparison indicates that the number may not accurately reflect the measurement result value, adjusting the number using an adjustment factor.

2. A method as in claim 1, where the adjustment factor is a constant.

3. A method as in claim 1, where the wireless communications system comprises a base station and a mobile station, and where the adjustment factor has a value that is a function of a distance between the base station and the mobile station.

4. A method as in claim 1, where the wireless communications system comprises a base station and a mobile station, and where the adjustment factor has a value that is determined by the mobile station and reported to the base station.

5. A method as in claim 4, where the adjustment factor is computed by the mobile station by:
during a period of time when the obtained codes do not accurately reflect the actual measurement result values, determining a difference between individual ones of actual measurement result values and a threshold measurement result value;
averaging the difference values; and
reporting the average of the difference values as the adjustment factor to the base station.

6. A method as in claim 1, where N is equal to 16.

7. A method as in claim 1, where the threshold is equal to −16.25 dB.

8. A method as in claim 5, where the threshold measurement result value is equal to −15.5 dB.

9. A method as in claim 1, where making a measurement from the forward channel measures a pilot channel.

10. A method as in claim 9, where making a measurement determines a value for (Ec/Nt)_{Pilot}.

11. A method as in claim 4, where reporting the value of the adjustment factor to the base station occurs at intervals that are longer than intervals between the mobile station making a full channel quality indicator (CQI) report to the base station.

12. A method as in claim 5, where reporting the average of the difference values as the adjustment factor to the base station occurs at intervals that are longer than intervals between the mobile station making a full channel quality indicator (CQI) report to the base station.

13. A method as in claim 4, where reporting the value of the adjustment factor to the base station occurs at intervals that are specified to the mobile station in signaling received from the base station.

14. A wireless communication system, comprising:
a mobile station comprising circuitry and a computer program controlling operation of the circuitry to make a measurement from a forward channel to obtain a measurement result value, to quantize the measurement result value in accordance with an N level quantization to obtain a code, and to report the code on a reverse channel; and
a base station comprising circuitry and a computer program controlling operation of the circuitry to convert the code to a number, to compare the number to a threshold and, if the comparison indicates that the number may not accurately reflect the measurement result value, to adjust the number using an adjustment factor.

15. A wireless communication system as in claim 14, where the adjustment factor is a constant.

16. A wireless communication system as in claim 14, where the adjustment factor has a value that is a function of a distance between the base station and the mobile station.

17. A wireless communication system as in claim 14, where the adjustment factor has a value that is determined by the mobile station and reported to the base station.

18. A wireless communication system as in claim 17, where the circuitry and the computer program controlling operation of the circuitry of the mobile station determines the value of the adjustment factor by being responsive to a period of time when the obtained codes do not accurately reflect the actual measurement result values to determine a difference between individual ones of actual measurement result values and a threshold measurement result value; to average the difference values; and to report the average of the difference values as the adjustment factor to the base station.

19. A wireless communication system as in claim 14, where N is equal to 16.

20. A wireless communication system as in claim 14, where the threshold is equal to −16.25 dB.

21. A wireless communication system as in claim 18, where the threshold measurement result value is equal to −15.5 dB.

22. A wireless communication system as in claim 14, where the mobile station circuitry and computer program controlling operation of the circuitry makes a measurement from a pilot channel.

23. A wireless communication system as in claim 14, where the mobile station circuitry and computer program controlling operation of the circuitry determines a value for (Ec/Nt)_{Pilot}.

24. A wireless communication system as in claim 17, where the mobile station reports the value of the adjustment factor to the base station at intervals that are longer than intervals between the mobile station making a full channel quality indicator (CQI) report to the base station.

25. A wireless communication system as in claim 17, where the mobile station reports the average of the difference values as the adjustment factor to the base station at intervals that are longer than intervals between the mobile station making a full channel quality indicator (CQI) report to the base station.

26. A wireless communication system as in claim 17, where the mobile station reports the value of the adjustment factor to the base station at intervals that are specified to the mobile station in signaling received from the base station.

27. A network infrastructure component of a wireless communication system, comprising circuitry and a computer program controlling operation of the circuitry to receive a code from a mobile station, the code being indicative of a quantized result of a measurement result value obtained from a forward channel, to convert the code to a number, to compare the number to a threshold and, if the comparison indicates that the number may not accurately reflect the measurement result value, to adjust the number using an adjustment factor.

28. A network infrastructure component as in claim 27, where the adjustment factor is a constant.

29. A network infrastructure component as in claim 27, where the adjustment factor has a value that is a function of a distance between a base station and the mobile station.

30. A network infrastructure component as in claim 27, where the adjustment factor has a value that is determined by the mobile station and reported to a base station.

31. A mobile station component of a wireless communication system, comprising circuitry and a computer program controlling operation of the circuitry to make a measurement from a forward channel to obtain a measurement result value, to quantize the measurement result value in accordance with an N level quantization to obtain a code, to report the code on a reverse channel to a wireless communication system infrastructure component, and to determine a value of an adjustment factor for use by the infrastructure component when processing the code by being responsive to a period of time when the obtained codes do not accurately reflect actual measurement result values to determine a difference between individual ones of actual measurement result values and a threshold measurement result value, to average the difference values and to report the average of the difference values as the adjustment factor to the infrastructure component.

32. A mobile station component as in claim 31, where N is equal to 16 and where the threshold measurement result value is equal to −15.5 dB.

33. A mobile station component as in claim 31, where the measurement is made from a pilot channel to determine a value for (Ec/Nt)_{Pilot}.

34. A mobile station component as in claim 31, where the mobile station component reports the value of the adjustment factor at intervals that are longer than intervals between the mobile station making a full channel quality indicator (CQI) report.

35. A mobile station as in claim 31, where the mobile station component reports the value of the adjustment factor at intervals that are specified to the mobile station component in signaling received from a base station.

36. Wireless network apparatus comprising means for receiving a code from a mobile station, the code being indicative of a quantized result of a measurement result value obtained from a forward channel, and for converting the code to a number, comparing the number to a threshold and, if the comparison indicates that the number may not accurately reflect the measurement result value, for adjusting the number using an adjustment factor.

37. Wireless network apparatus as in claim 27, where the adjustment factor has a value that is one of a constant; a function of a distance between a base station and the mobile station; and determined by the mobile station and reported to a base station.

38. Wireless network apparatus comprising means for making a measurement from a received channel to obtain a measurement result value; means for quantizing the measurement result value in accordance with an N level quantization to obtain a code; and means for reporting the code to a wireless communication system infrastructure component, further comprising means for determining a value of an adjustment factor for use by the infrastructure component when processing the code, said value determining means being responsive to an occurrence of a period of time when an obtained code does not accurately reflect actual measurement result values for determining a difference between individual ones of actual measurement result values and a threshold measurement result value, for averaging the difference values and for reporting the average of the difference values as the adjustment factor to the infrastructure component.

39. Wireless network apparatus as in claim 38, where the measurement is made from a pilot channel for determining a value for (Ec/Nt)_{Pilot}.

40. Wireless network apparatus as in claim 38, where said value determining means reports the value of the adjustment factor at intervals that are at least one of: longer than intervals between making a full channel quality indicator (CQI) report; and specified to the mobile station component in signaling received from a base station.
